(19) United States
(12) Patent Application Publication
(10) Pub. No.: US 2009/0316267 A1
(43) Pub. Date: Dec. 24, 2009

(54) MULTILAYER THIN-FILM STACK AND OPTICAL ELEMENT EMPLOYING SAME

(75) Inventor: PO-WEN CHAN, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/239,736

(22) Filed: Sep. 26, 2008

(30) Foreign Application Priority Data
Jun. 24, 2008 (CN) 200810302291.4

(51) Int. Cl. G02B 1/10; G02B 5/04

(52) U.S. Cl. 359/586; 359/837; 359/359

(57) ABSTRACT

An optical element includes one or more transparent prisms and a multilayer optical thin-film formed on the transparent prisms. The multilayer optical thin-film includes a transparent substrate and a multilayer optical thin-film formed on the transparent substrate. The multilayer optical thin-film includes a plurality of high refractive index layers having a refractive index of more than 2.1 and a plurality of medium refractive index layers. The medium refractive index layers have a refractive index of one of to 1.79 and 1.81 to 1.86. The medium refractive index layers and the high refractive index layers are laminated in alternating fashion.

### BACKGROUND

1. Technical Field

The present disclosure generally relates to an optical element and, in particular, to a optical element provided with a multilayer optical film.

2. Description of the Related Art

FIG. 4 and FIG. 5 are graphs showing spectral transmittance characteristics of two typical optical elements, such as dichroic mirrors. The structure of the films formed on the two dichroic mirrors are represented by the formulas (0.5HL0.5H)¹² and (2HL)¹⁴ respectively, wherein H represents a high refractive index layer and L represents a low refractive index layer, H and L are set at ¼ lambda of a reference wavelength associated with the film, and the superscript, e.g., 12 or 14 represents the number of repetitions of the structure, enclosed by the parentheses, used in the film.

The light has an obviously wider reflected S-polarized component wavelength range than the reflected P-polarized component wavelength range and therefore the reflection characteristics of the two typical red reflecting dichroic mirrors have polarization dependency, as shown in FIG. 4 and FIG. 5. When these dichroic mirrors are used in a projector, brightness level and contrast level of the projector tend to be undesirably decreased, and a clear image cannot be projected.

What is needed, therefore, is an optical element that can overcome the above-described shortcomings.

### BRIEF DESCRIPTION OF THE DRAWINGS

The present multilayer thin-film stack and optical element are described in detail hereinafter, by way of example and description of preferred and exemplary embodiments thereof and with references to the accompanying drawings, in which:

FIG. 1 is a schematic view of an optical element according to an exemplary embodiment;

FIG. 2 show a film structure of the optical element of FIG. 1

FIG. 3 is a graph showing transmittance characteristics of the optical element of FIG. 1;

FIG. 4 is a graph showing transmittance characteristics of an optical element according to a related art; and

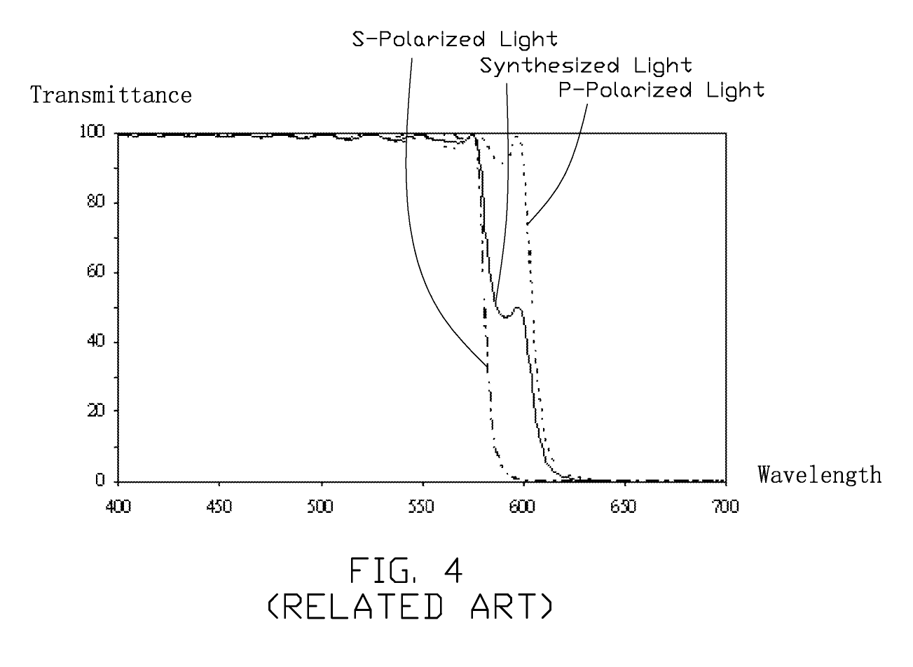

FIG. 5 is a graph showing transmittance characteristics of an optical element according to another related art.

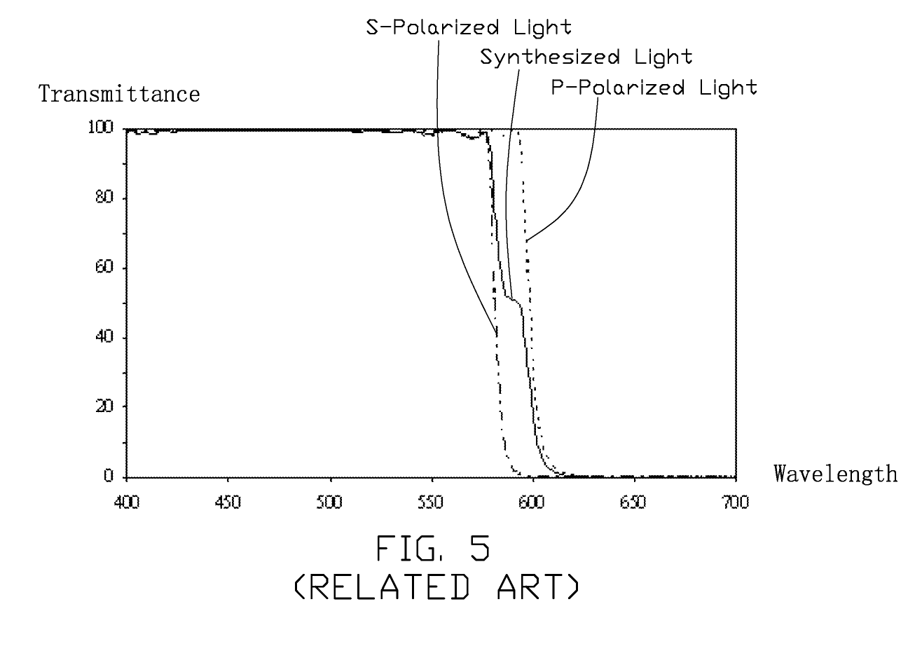

### DETAILED DESCRIPTION

A detailed explanation of an optical element having a multilayer thin-film stack according to an exemplary embodiment will now be made with references to the drawings attached hereto.

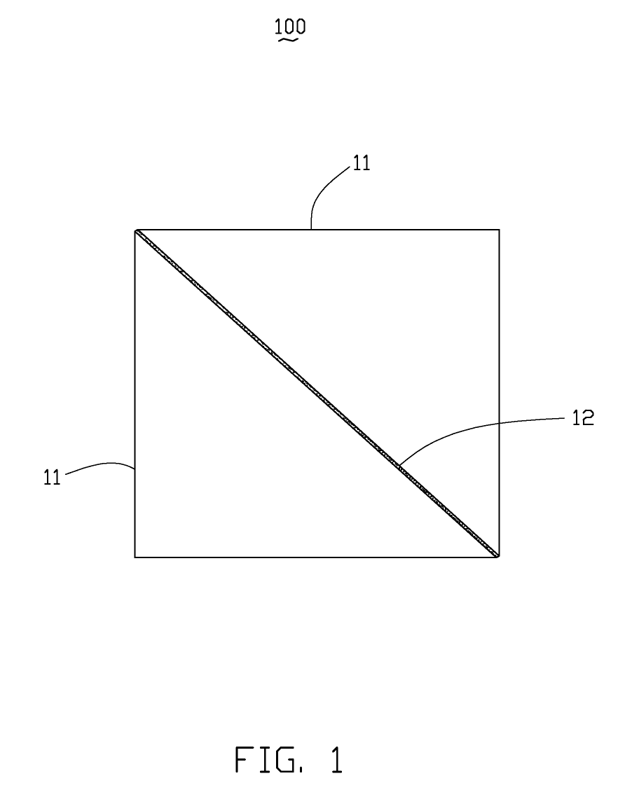

Referring to FIG. 1, an optical element 100 according to the exemplary embodiment is shown. The optical element 100 includes two transparent prisms 11, and a multilayer thin-film stack 12 formed between the two transparent prisms 11.

The optical element 100 may be a beam splitter prism which is used for splitting an incident light into a P-polarized light and a S-polarized light.

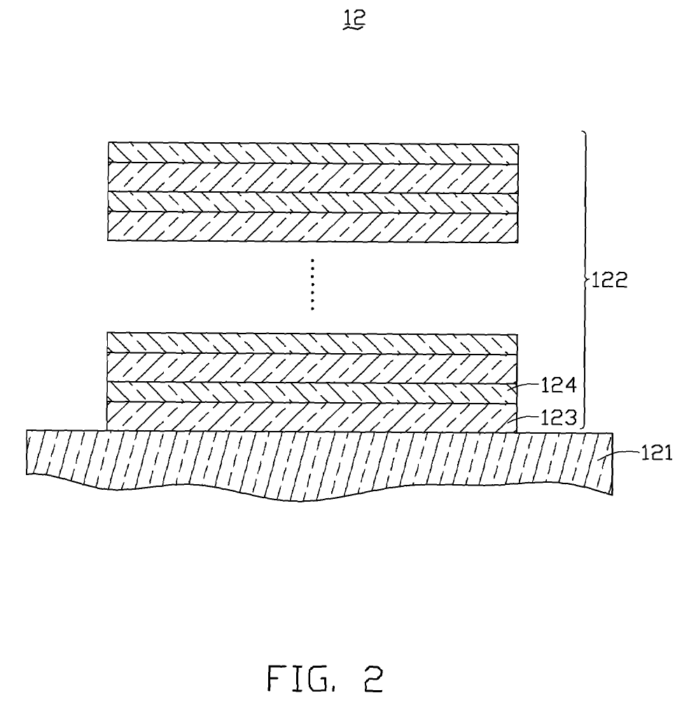

Referring also to FIG. 2, the multilayer thin-film stack 12 includes a transparent substrate 121, a multilayer optical thin-film 122 formed on the transparent substrate 121. The transparent substrate 121 is made of transparent glass or resin. The number of repetitions of multilayer optical thin-film 122 is determined by the wavelength range of reflected light or transmitted light entered therein. In this embodiment, the number of repetitions of the structure is 18 and the wavelength range of the reflected light thereof is 400 nm to 440 nm and the wavelength range of the transmitted light is 480 nm to 670 nm.

The multilayer optical thin-film 122 includes a plurality of high refractive index layers 123 and a plurality of medium refractive index layers 124. The high refractive index layers 123 and the medium refractive index layers 124 are laminated in alternating fashion. The structure of the multilayer optical thin-film 122 is represented by the formula (HM)¹⁸, wherein H represents the high refractive index layer and M represents the medium refractive index layer, the 18 represents the number of repetitions of the structure. The high refractive index layers 123 may be a titanium dioxide (TiO₂) layer, tantalic oxide (Ta₂O₅) layer, or a niobium pentoxide (Nb₂O₅) layer, having a refractive index of more than 2.1. The medium refractive index layers 124 are made of M2 or M3 produced by Merck Corporation and have a refractive index range of from 1.71 to 1.79 or from 1.81 to 1.86, respectively. Each of the high refractive index layers 123 have a same optical length (optical length of the layer' thickness) with the medium refractive index layers 124.

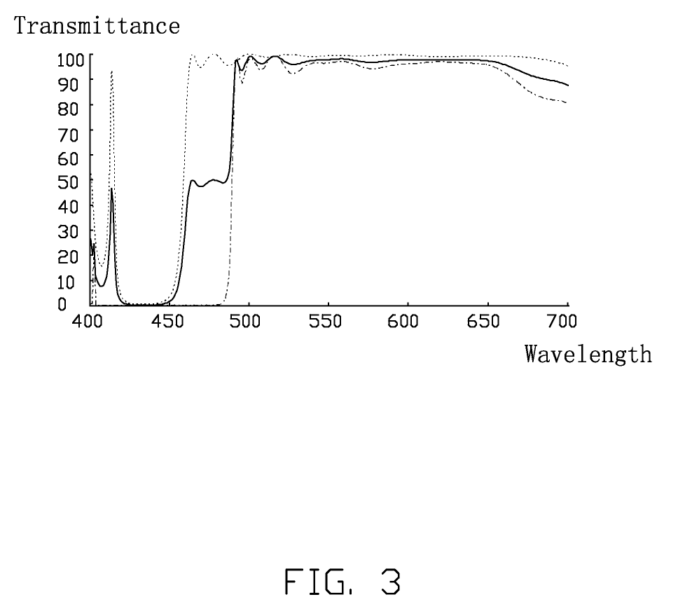

Referring to FIG. 3, results of measuring performance of the multilayer thin-film stack 12 are shown. In this figure, the solid line stands for average transmittance to wavelength, the dotted line stands for transmittance of P-polarized light in relation to wavelength, and dash-dotted line stands for spectrogram of S-polarized light. The abscissa of the graph represents wavelengths and the ordinate of the graph represents transmittance. The incoming light beam entered into the multilayer thin-film stack 12 has an angle of incidence of 45 degrees, while the reference wavelength of the incoming light beam was 475 nm. From the FIG. 3, we can see that the full width at half maximum of the P-polarized light and the S-polarized light is about 40 nm. Therefore, offset effect between the P-polarized light and the S-polarized light can be decreased.

As described above, the multilayer thin-film stack 12 employed in the optical element 100 is advantageous to decrease the offset between the P-polarized light and the S-polarized and cause to continue in the same reflecting index of the multilayer optical thin-film 122 utilizing the medium refractive index layer when incident angle of incident light beams change. Therefore, when this optical element 100 is used in a projector, filtering effect, brightness and contrast levels are increased, and a clear image can be projected.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A multilayer thin-film stack, comprising:
a transparent substrate; and
a multilayer optical thin-film formed on the transparent substrate, comprising:
a plurality of high refractive index layer having a refractive index of more than 2.1; and
a plurality of medium refractive index layer having a refractive index ranging from 1.71 to 1.79 or from 1.81 to 1.86, the plurality of medium refractive index layer and the plurality of high refractive index layer being laminated in alternating fashion.

2. The multilayer thin-film stack as claimed in claim 1, wherein the transparent substrate is made of a transparent glass.

3. The multilayer thin-film stack as claimed in claim 1, wherein the transparent substrate is made of a transparent resin.

4. The multilayer thin-film stack as claimed in claim 1, wherein each of the high refractive index layers has a same optical thickness with each of the medium refractive index layer.

5. The multilayer thin-film stack as claimed in claim 1, wherein a number of repetitions of the multilayer optical thin-film is 18.

6. The multilayer thin-film stack as claimed in claim 1, wherein the plurality of high refractive index layers are made of an oxide selected from the group consisting of titanium dioxide, tantalic oxide, and niobium pentoxide.

7. The multilayer thin-film stack as claimed in claim 1, wherein the medium refractive index layer is made of a material selected from the group consisting of M2 and M3.

8. A beam splitter prism, comprising:
two transparent tri-prisms; and
a multilayer optical thin-film positioned between the two transparent tri-prisms, the multilayer optical thin-film comprising:
a transparent substrate; and
a multilayer optical thin-film formed on the transparent substrate, comprising:
a plurality of high refractive index layer having a refractive index of more than 2.1; and
a plurality of medium refractive index layer having a refractive index ranging from 1.71 to 1.79 or from 1.81 to 1.86, the plurality of medium refractive index layers and the plurality of high refractive index layers being laminated in alternating fashion.

9. The beam splitter prism as claimed in claim 8, wherein the transparent substrate is made of a transparent glass.

10. The beam splitter prism as claimed in claim 8, wherein the transparent substrate is made of a transparent resin.

11. The beam splitter prism as claimed in claim 8, wherein each of the high refractive index layers has a same optical thickness with each of the medium refractive index layers.

12. The beam splitter prism as claimed in claim 8, wherein a number of repetitions of the multilayer optical thin-film is 18.

13. The beam splitter prism as claimed in claim 8, wherein the plurality of high refractive index layers are made of an oxide selected from the group consisting of titanium dioxide, tantalic oxide and, niobium pentoxide.
